(19) United States
(12) Patent Application Publication
(10) Pub. No.: US 2023/0182152 A1
(43) Pub. Date: Jun. 15, 2023

(54) MULTI-CYCLONE VACUUM EXCAVATION SYSTEM

(71) Applicant: Michael Leonard Anderson, Temecula, CA (US)

(72) Inventor: Michael Leonard Anderson, Temecula, CA (US)

(21) Appl. No.: 18/078,768

(22) Filed: Dec. 9, 2022

Related U.S. Application Data
(60) Provisional application No. 63/288,501, filed on Dec. 10, 2021.

(51) Int. Cl. B04C 5/28; B04C 5/12; B04C 9/00; E02F 3/88; E02F 7/00

(52) U.S. Cl. CPC B04C 5/28; B04C 5/12; B04C 9/00; E02F 3/8816; E02F 7/00; B04C 2009/002

(57) ABSTRACT

A vehicle may include an undercarriage with a vacuum spoils tank and a multi-cyclone body housing mounted thereon. A vacuum spoils tank may be in fluid connection to the multi-cyclone body housing. The vacuum spoils tank may include both an inlet and an outlet. A multi-cyclone body may be housed within the multi-cyclone body housing. The housing may be positioned at the vacuum spoils tank outlet, and the multi-cyclone body may carry a plurality of mini-cyclonic chambers. Each mini-cyclonic chamber may include an outlet tube and a mini-cyclonic separator. The mini-cyclonic separator may be in fluid communication with the vacuum spoils tank outlet. The outlet tube may be in fluid communication with a multi-cyclone body housing outlet and a filtration system

### CROSS-REFERENCE TO RELATED APPLICATION

This application claims priority to U.S. Provisional Patent Application No. 63/288,501 filed on Dec. 10, 2021 and entitled “Multi-Cyclone Vacuum Excavation System” the entire disclosure of which is expressly incorporated by reference herein.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

The present invention generally relates to a vacuum excavation system for an excavation vehicle.

Traditional forms of excavation employ hydraulic excavators and backhoes, as well as hand tools to excavate and expose utilities. In urban environments, these systems are typically too large or dangerous to employ and smaller, safer, and less invasive equipment is needed. Vacuum excavation techniques are more suitable for urban environments as a non-mechanical, non-destructive alternative using either water or air to move material. Water or “hydro” excavation uses high-pressure water to loosen the materiel and create a cavity while a hydro excavator truck simultaneously suctions the wet, excavated material into a tank and carries it offsite. Hydro excavation allows for quick and precise excavations requiring less backfill and labor with less environmental impact than conventional mechanical excavation. Air excavation loosens the excavation material using compressed air rather than water and also allows use of the excavated material as backfill. Furthermore, filters must be used to keep the excavated material contained within the system and prevent it from being carried out with the system exhaust. These filters typically clog after use and, depending on the excavation material, these clogs might add significant delay to job completion.

Use of one technique over the other depends on the parameters of the excavation. Hydro excavation uses water to soak and soften the soil. The resulting slurry cannot be used as backfill. Air excavation can blow material to unintended parts of a worksite and create significant dust that requires wetting the excavation material before and/or during the job. Contractors must determine which technique is suitable for the job and select one method and equipment over the other. Where both methods are required, two types of equipment will be needed to complete the excavation.

Microtrenching presents significant obstacles when using traditional water or air excavation techniques. In microtrenching, the excavation equipment digs a narrow trench of one to two inches wide and about two feet deep. Multiple conduits may then be placed within the trench. This technique is particularly useful on open highways, sidewalks, parking lots and driveways, and other congested or sensitive areas. Filtration systems on traditional hydro excavation units include a paper filter that are often overwhelmed when cutting dry material with the microtrenchers. When microtrenching, filters had to be monitored constantly, as to not become dirty, packed full of spoils material, or otherwise rendered ineffective. Excessive bypass may cause massive damage to the blower mechanism on traditional equipment. One solution was to employ baghouse filters on equipment that was built to excavate dry material. While these filters would work for dry excavation, hydro excavation and even damp conditions would still allow the filter to become easily clogged.

Typical vacuum excavation systems employ a large, hollow cyclonic separator chamber and downstream filtration (e.g., a paper filter). Restriction of the vacuum stream could render the vacuum system ineffective or cause significant damage to the system. A large, hollow cyclonic chamber permits nearly unrestricted flow from the spoils tank, where larger particulate matter is collected, through the paper filter, through a blower, and out to exhaust. Some fine particulate is collected within the large cyclonic chamber, but most of the fine particulate is collected by the paper filter before the stream enters the blower. Because only a portion of the finer particulate matter is separated from the immiscible stream, a paper filter may soon become ineffective and clogged. Using this typical excavation unit, filters may have to be changed and cleaned several times before a job can be completed. In a worst case scenario, a filter may continue to be used after becoming ineffective and allow particulate to enter the blower. Particulate within the blower during operation may cause significant damage to the unit resulting in costly delays an inefficient excavation. Thus, there is a need for excavation equipment that can employ both water and air and also eliminate the need for extensive filtering of the exhaust that leads to clogged filter components.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more or all of the features and advantages described in this summary.

A vehicle includes an undercarriage with a vacuum spoils tank and a multi-cyclone body housing mounted thereon. A vacuum spoils tank may be in fluid connection to the multi-cyclone body housing. The vacuum spoils tank may include both an inlet and an outlet. A multi-cyclone body may be housed within the multi-cyclone body housing. The housing may be positioned between the vacuum spoils tank outlet and a vacuum system exhaust, and the multi-cyclone body may carry a plurality of mini-cyclonic chambers. A lower portion of each mini-cyclonic chamber may be in fluid communication with the spoils tank outlet. An upper portion of each mini-cyclonic chamber may be in fluid communication with the vacuum system exhaust.

### BRIEF DESCRIPTION OF THE DRAWINGS

FIG. 1 illustrates one embodiment of a typical vacuum excavator vehicle;

FIG. 2A illustrates one embodiment of a mini-cyclone body carrying multiple mini-cyclonic chambers;

FIG. 2B illustrates one embodiment of a mini-cyclonic chamber carried by the multi-cyclone body; and

FIG. 3 illustrates one embodiment of multi-cyclone vacuum excavation system.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

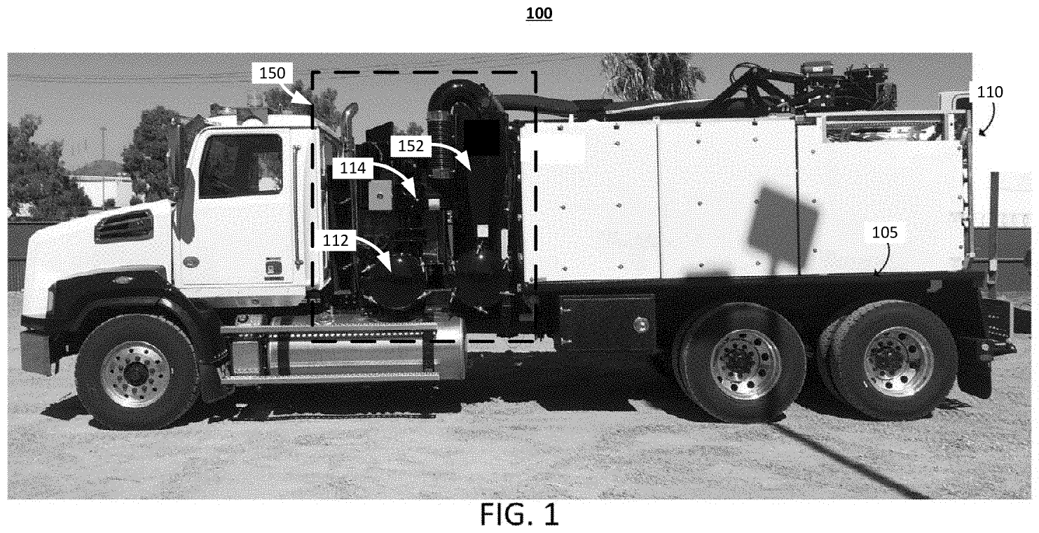

With reference to FIG. 1, a typical vacuum excavator vehicle 100 includes an undercarriage 105 having a vacuum spoils tank 110 and a vacuum excavation system 150 mounted thereon. A typical vacuum excavation system 150 may include one or more hollow cyclonic separator chambers 152. The vacuum excavation system 150 is in fluid communication with the spoils tank 110 and with various other components (hoses, valves, inlets, outlets, etc.) of the system 150 in order to accelerate, intercept, and deposit excavation material. The vehicle 100 may also include a blower module, a paper filter canister 112 carrying a paper filter (not shown) and a two- or four-way valve 114. The four-way valve 114 may be employed to select forward or reverse flow of an excavation stream within the vacuum excavation system 150.

Cyclonic separator systems are commonly used to segregate immiscible material of a stream, such as when an excavator cuts or removes material to create a cavity using air or water. Separator systems are commonly used to separate immiscible excavation material. The material mixed with air or water enters cyclonic chambers through inlets that are tangential to the curvature of each of the cyclonic chambers. As a result of the velocity and the tangential angle at which the excavation material stream enters the cyclonic chamber, centrifugal forces act on the stream and cause it to spin around the curvature of the cyclonic chamber.

Centrifugal forces acting on excavation material stream cause the material to move either away from or towards the center of the cyclonic chamber. A difference in the mass and densities of excavation material cause the heavier material to coalesce on the inner wall of the cyclonic chamber and travel in a downwards direction through the cyclonic chamber due to the force of gravity, while the lighter fluid (i.e., air or water) remains closer to the center of the cyclonic chamber forming a central upward moving column of air or water that exits through an aperture positioned in the upper covering of the cyclonic chamber.

To ensure effective light/heavy excavation material separation, the incoming excavation stream flows at high velocity to create a greater centrifugal force for separation of the heavier material from the lighter material. As well, an inlet aperture of the mini-cyclonic chamber is designed to a minimum size based on how much lighter excavation material is being separated out. For example, the inlet aperture may be increased or decreased based on the excavation material, worksite conditions, excavation medium, etc., to ensure a desired level of separation between the medium and spoils and to reduce the amount of spoils that is collected by a further filtration system (e.g., the paper filter canister 112 carrying the paper filter) and cleanliness of the system exhaust. There are further limits to the design of the tangential inlets to each of the cyclonic chambers to create the desired high momentum and flow rate of the incoming excavation material.

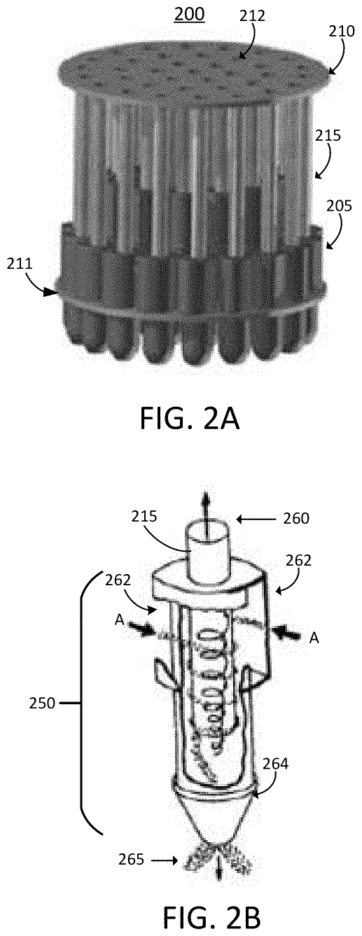

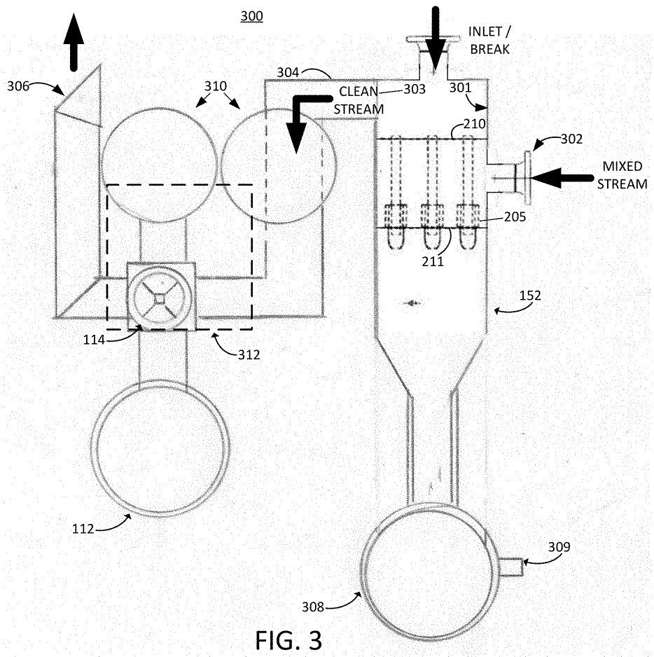

FIG. 2A illustrates an embodiments of a multi-cyclone body 200 carrying multiple mini-cyclonic chambers 205. The body may include an upper mounting plate 210 and a lower mounting plate 211. The upper mounting plate 210 includes apertures 212 for each of the cyclone chambers 205. Each aperture may carry an outlet tube 215 to return clean fluid (i.e., air or water) through a filtration system. As shown by FIG. 2B, a mini-cyclonic chamber 205 may include an outlet tube 215 and a mini-cyclonic separator 250. For example, the mini-cyclonic separator 250 may include an upper clean fluid outlet 260, one or more immiscible stream inlets 262, a nozzle 264, and a lower particulate outlet 265. In use, an immiscible stream containing particulate matter (e.g., an excavation material stream) and excavation medium (e.g., air, water, etc.), where the particulate matter (e.g., spoils) has a mass that is greater than the excavation medium, passes into the mini-cyclonic separator 250 through the immiscible stream inlet 262. The one or more immiscible stream inlets 262 may force the immiscible stream into a counter-clockwise downwards direction “A”, increasing the flow velocity and imparting a centrifugal force upon the immiscible stream. The heavier particulate coalesces on the inner surface of the walls of the separator 250 and drops from the stream through particulate outlet 265 while the lighter fluid of the immiscible stream rises by vacuum force through the upper clean fluid outlet 260 and continues through the system 300 (FIG. 3) to the exhaust 306. The particulate are then thrown downwards past the vortex of the mini-cyclonic separator 250 into a collection chamber 308 (FIG. 3), the scrubbed immiscible stream then rises upwards through the outlet tube 215.

The body 200 may be permanently affixed to an inner wall of the multi-cyclone vacuum excavation system housing 152 via one or more of the upper mounting plate 210 and the lower mounting plate 211. In other embodiments, the body 200 is sealed within the housing 152 generally at the upper mounting plate 210 and/or the lower mounting plate 211, but may be configured to be removable from the multi-cyclone vacuum excavation system housing 152 so that it may be exchanged or cleaned when needed and replaced for continued use. The immiscible stream may enter the housing 152 below the upper mounting plate 210 and above the lower mounting plate 211.

The body 200 may include a plurality of mini-cyclonic chambers 205 based on the specification of the multi-cyclonic vacuum excavator system. For example, in a unit capable of excavating 3,000 cubic feet per minute (CFM), the body may include between 20 and 30 mini-cyclonic chambers 205. In a 1,000 CFM system, the body may include between 10 and 20 mini-cyclonic chambers 205. Other configurations and numbers of mini-cyclonic chambers 205 are possible depending on the needs of the job and system.

FIG. 3 illustrates an embodiment of the multi-cyclone vacuum excavation system 150 as employed on a vacuum excavator vehicle 100. The multi-cyclone body 200 may be sealingly-affixed to an inner wall 301 of the multi-cyclone vacuum excavation system housing 152 by one or more of the upper mounting plate 210 and the lower mounting plate 211.

In operation, an excavation material stream enters the inlet portion 302 of the system 100 from the spoils tank 110 below the upper mounting plate 210 and above the lower mounting plate 211. The stream is separated into medium (air, water, etc.) and spoils by the mini-cyclonic chambers 205 of the multi-cyclone body 200. A lighter excavation medium such as air or water may be lifted up and out of the housing 152 through the clean stream outlet 303 while the heavier excavation material (i.e., dirt, concrete, asphalt, etc.) drops through the nozzle 264 into a collection chamber 308 below the mini-cyclone body 200. The collection chamber 308 may be emptied by a vacuum port 309 or other opening to the collection chamber 308 or may be pushed out to the spoils tank 110. The clean medium is passed via a conduit 304 toward an exhaust portion 306. The clean stream may pass through the four-way valve 114 to the paper filter 112, though a blower unit 312 and one or more silencers 310 along the conduit 304 before it leaves the system 150 via the exhaust portion 306. The silencers 310 may reduce the sound level of the system 150 and the excavation material stream within the system 150.

Thus, the embodiments described herein provide a technical solution to the problem of efficiently and effectively separating different types of immiscible excavation streams (e.g., both dry and wet). The solutions described herein allow separation of excavation medium from excavation spoils regardless of the material and without relying on easily-clogged paper filtration and time-consuming filter replacement to protect the blower unit.

The invention can provide various combinations of all of the features revealed and explained in conjunction with individual embodiments of the invention, and advantageous effects of these can therefore be realized simultaneously.

Further, the figures depict preferred embodiments of a multi-cyclone vacuum excavation vehicle for purposes of illustration only. One skilled in the art will readily recognize from the discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope of the invention.

1. A vacuum excavation vehicle comprising:
an undercarriage;
a vacuum spoils tank operatively mounted to the undercarriage, the vacuum spoils tank having an inlet and an outlet; and
a multi-cyclone body housing positioned at the vacuum spoils tank outlet, the multi-cyclone body housing carrying a multi-cyclone body, the multi-cyclone body carrying the plurality of mini-cyclonic chambers, each mini-cyclonic chamber including an outlet tube and a mini-cyclonic separator, the mini-cyclonic separator being in fluid communication with the vacuum spoils tank outlet, the outlet tube being in fluid communication with a multi-cyclone body housing outlet and a filtration system.

2. The vacuum excavation vehicle of claim 1, further comprising a blower unit configured to pull an immiscible stream from the vacuum spoils tank into the mini-cyclonic separator, the mini-cyclonic separator configured to separate the immiscible fluid by centrifugal force and deposit a first portion of the immiscible fluid in a collection chamber below the mini-cyclonic separator.

3. The vacuum excavation vehicle of claim 2, wherein the blower unit is further configured to pull a second portion of the immiscible stream towards the blower.

4. The vacuum excavation vehicle of claim 1, wherein the outlet of the vacuum spoils tank includes an immiscible stream inlet of the multi-cyclone body.

5. The vacuum excavation system of claim 1, further comprising a conduit leading from the multi-cyclone body housing above the outlet tube of each mini-cyclonic chamber of the plurality of mini-cyclonic chambers.
